(19) United States
(12) Patent Application Publication
(10) Pub. No.: US 2025/0001778 A1
(43) Pub. Date: Jan. 2, 2025

(54) PRINTING METHOD AND ROBOT SYSTEM

(71) Applicant: SEIKO EPSON CORPORATION, Tokyo (JP)

(72) Inventor: Hidetoshi SAITO, FUJIMI-MACHI (JP)

(21) Appl. No.: 18/757,581

(22) Filed: Jun. 28, 2024

(30) Foreign Application Priority Data
Jun. 29, 2023 (JP) 2023-106747

(51) Int. Cl. B41J 25/00; B41J 2/14

(52) U.S. Cl. CPC B41J 25/001; B41J 2/14201

(57) ABSTRACT

A printing method for performing printing on a print object by using a print head provided with a first robot, the printing method includes performing printing by relatively moving the print head and the print object, while vibrating at least one of the print head and the print object, so that relative vibration between the print head and the print object is reduced. The printing is performed by detecting vibration of either the print head or the print object, and by vibrating at least one of the print head and the print object.

### CROSS-REFERENCE TO RELATED APPLICATIONS

The present application is based on, and claims priority from JP Application Serial Number 2023-106747, filed Jun. 29, 2023, the disclosure of which is hereby incorporated by reference herein in its entirety.

### BACKGROUND OF THE INVENTION

### 1. Technical Field

The present disclosure relates to a printing method and a robot system.

### 2. Related Art

The robot system described in JP-A-2023-202781 has a print head attached to the tip end. In this robot system, printing is performed on a print object by ejecting ink from the print head toward the print object while moving the print head along the print trajectory by moving the robot.

However, in the robot system of JP-A-2023-202781, if the print head and the print object are vibrating relatively, that is, if there is relative displacement between the print head and the print object other than movement of the print head along a print trajectory, the printing is blurred even when the print head is moved along the print trajectory, and print quality is degraded.

### SUMMARY OF THE INVENTION

A printing method of the present disclosure is a printing method of performing printing on a print object using a print head, which is provided with a first robot, the printing method includes performing printing by relatively moving the print head and the print object, while vibrating at least one of the print head and the print object, so that relative vibration between the print head and the print object is reduced.

A robot system according to this disclosure includes a first robot, which has a print head for printing on a print object, wherein the printing is performed by relatively moving the print head and the print object, while vibrating at least one of the print head and the print object, so that relative vibration between the print head and the print object is reduced.

### BRIEF DESCRIPTION OF DRAWINGS

FIG. 1 is an overall view of a robot system according to a first embodiment.

FIG. 2 is a schematic view showing a printing work.

FIG. 3 is a plan view showing a first vibration generation device.

FIG. 4 is a plan view showing a detection element.

FIG. 5 is a plan view showing a second vibration generation device.

FIG. 6 is a view showing how vibration is transmitted.

FIG. 7 is an overall view of the robot system according to a third embodiment.

FIG. 8 is an overall view of the robot system according to a fourth embodiment.

### DETAILED DESCRIPTION OF THE INVENTION

Hereinafter, a printing method and a robot system according to the present disclosure will be described in detail based on embodiments shown in the accompanying drawings.

### 1. First Embodiment

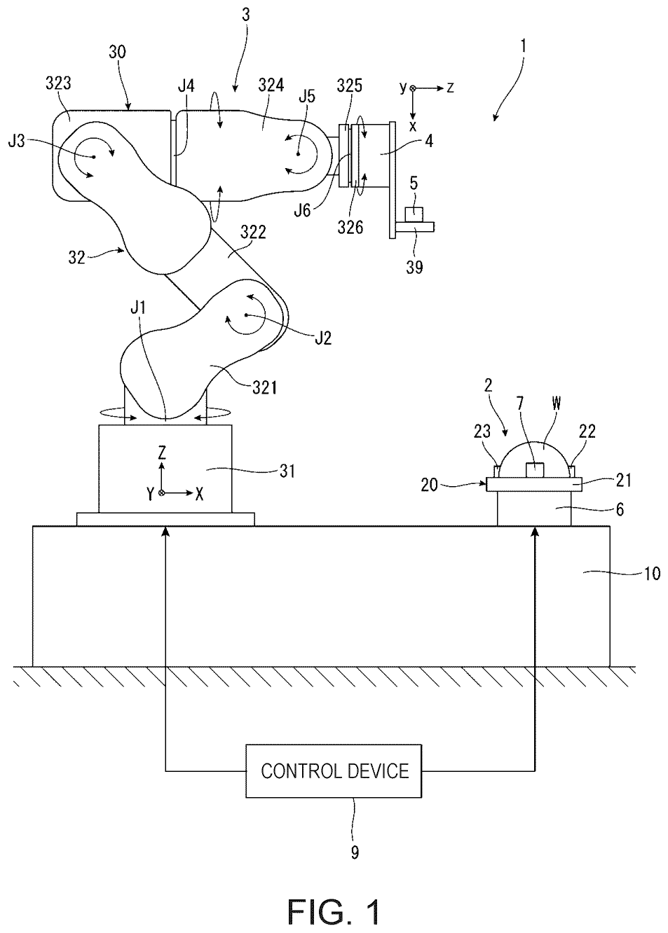

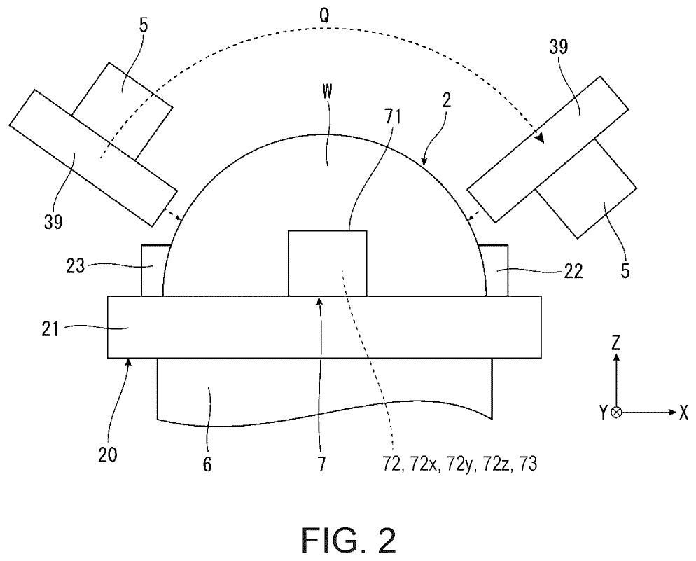

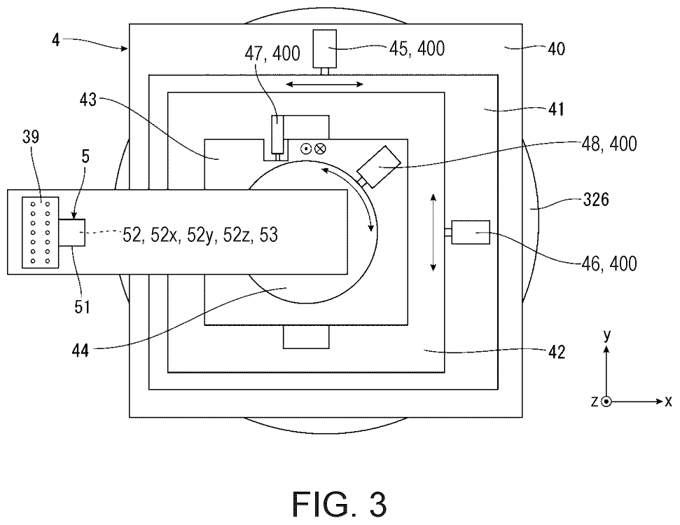

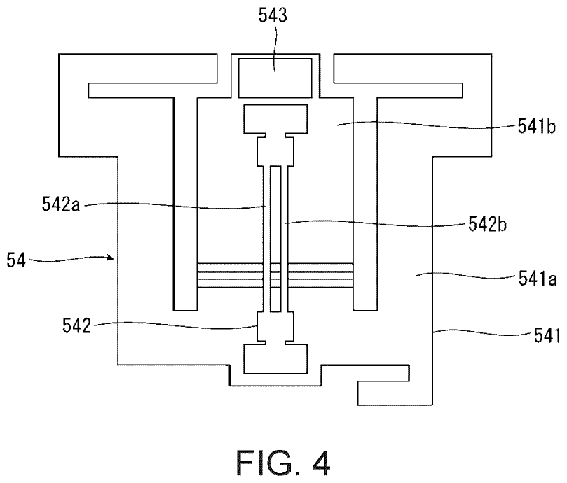

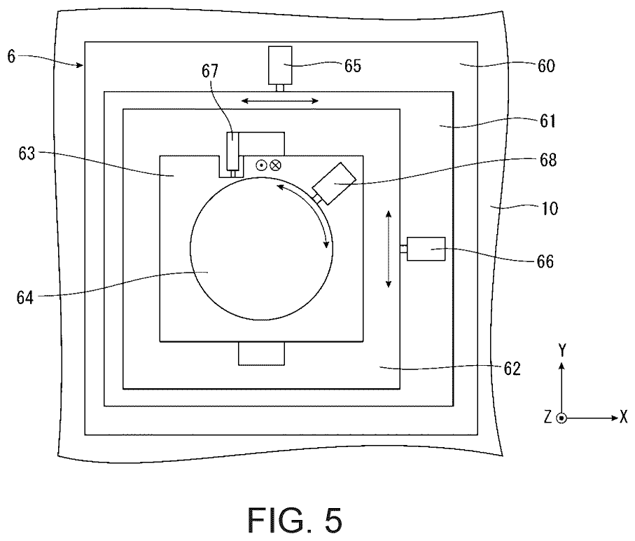

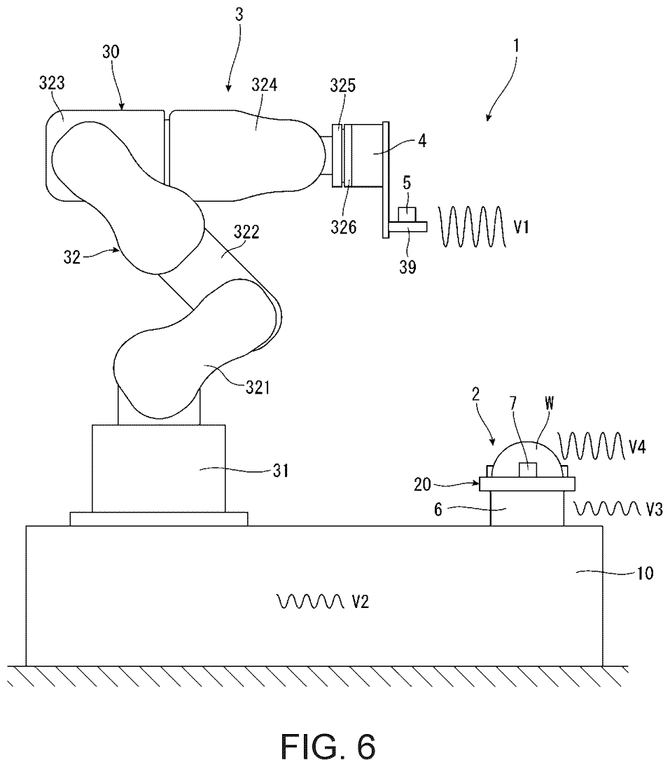

FIG. 1 is an overall view of a robot system according to a first embodiment. FIG. 2 is a schematic view showing a printing work. FIG. 3 is a plan view showing a first vibration generation device. FIG. 4 is a plan view showing a detection element. FIG. 5 is a plan view showing a second vibration generation device. FIG. 6 is a view showing how vibration is transmitted.

A robot system 1 shown in FIG. 1 is equipped with a holding device 2 that holds a print object W, a first robot 3 that performs printing on the print object W that is held by the holding device 2, and a control device 9 that controls the drive of the holding device 2 and the first robot 3. In the configuration shown in the drawings, both the holding device 2 and the first robot 3 are fixed to the mount base 10, but this is not limited to this, and each may be fixed to a different mount base. At least one of the holding device 2 and the first robot 3 may be fixed to a place other than the mount base, such as a floor, wall, or the like. At least one of the first robot 3 and the holding device 2 may not be fixed and can be configured to move by itself. The shape of the print object W is not particularly limited, although the print object W has a bowl-shape with a curved surface to be printed on. Hereinafter, each part of the robot system 1 will be described in order.

1.1. First robot 3

The first robot 3 has a robot main body 30, a print head 39, which is attached to a tip end portion of the robot main body 30, a first vibration generation device 4, which is located between the robot main body 30 and the print head 39, and a first vibration meter 5, which detects vibration of the print head 39. Hereinafter, for convenience of explanation, a robot coordinate system set at the base 31 of the robot main body 30 is indicated by an X-axis, a Y-axis, and a Z-axis. A tool coordinate system set at the tip portion of the robot arm 32 is indicated by an x-axis, a y-axis, and a z-axis. The tool coordinate system can be converted into the robot coordinate system based on the position and posture of the print head 39, which are obtained from outputs of encoders provided in joints J1 to J6.

The robot main body 30 is a six axes vertical articulated robot with six drive axes, and has a base 31, which is fixed to the mount base 10, and a robot arm 32, which is pivotably connected to the base 31. The robot arm 32 consists of six arms 321, 322, 323, 324, 325, 326 that are pivotably connected in this order from the base 31 side, and has six joints J1 to J6. Of these, the joints J2, J3, and J5 are bending joints, and the joints J1, J4, and J6 are torsion joints. The joints J1, J2, J3, J4, J5 and J6 are each provided with a motor and an encoder. The motor is driven by servo control that feeds back the encoder's output.

However, the configuration of the robot main body 30 is not particularly limited. For example, the number of arms provided in the robot arm 32 is not limited to six. The robot main body 30 may be a dual-arm robot, a horizontally articulated robot (SCARA robot), or the like.

The print head 39 is located at the tip end side of the robot arm 32, that is, the arm 326. The print head 39 is not particularly limited, but an inkjet head is used in this embodiment. The inkjet head has an ink chamber, a diaphragm provided on a wall surface of the ink chamber, and an ink ejection hole connected to the ink chamber (none of which are shown). Ink stored in the ink chamber is ejected from the ink ejection hole when the diaphragm vibrates. As shown in FIG. 2, printing is performed by ejecting ink from the print head 39 onto the surface to be printed on while the robot arm 32 moves the print head 39 with respect to the print object W at a predetermined print trajectory Q and speed.

The first vibration generation device 4 is located between the arm 326 and the print head 39. The first vibration generation device 4 is a device that applies vibration to the print head 39. As shown in FIG. 3, the first vibration generation device 4 is provided with a base portion 40 supported by the arm 326, a first stage 41 that moves in the x-axis direction with respect to the base portion 40, a second stage 42 that moves in the y-axis direction with respect to the first stage 41, a third stage 43 that moves in the z-axis direction with respect to the second stage 42, and a fourth stage 44 that rotates around the z-axis with respect to the third stage 43. The fourth stage 44 is provided with a print head 39.

Therefore, when the first stage 41 moves in the x-axis direction, the print head 39 vibrates in the x-axis direction; when the second stage 42 moves in the y-axis direction, the print head 39 vibrates in the y-axis direction; when the third stage 43 moves in the z-axis direction, the print head 39 vibrates in the z-axis direction; and when the fourth stage 44 rotates around the z-axis, the print head 39 vibrates around the z-axis. By appropriately combining these four vibrations, the print head 39 can be vibrated in various magnitudes and directions.

The first vibration generation device 4 has a first stage drive section 45 that moves the first stage 41 with respect to the base portion 40, a second stage drive section 46 that moves the second stage 42 with respect to the first stage 41, a third stage drive section 47 that moves the third stage 43 with respect to the second stage 42, and a fourth stage drive section 48 that moves the fourth stage 44 with respect to the third stage 43.

Each of the first, second, third, and fourth stage drive sections 45, 46, 47, and 48 is provided with a piezoelectric actuator 400 that drives the stage using expansion and contraction of piezoelectric elements due to energization. These stage drive sections drive stages by transmitting the vibrations of the piezoelectric actuators 400 to the first, second, third, and fourth stages 41, 42, 43, and 44. By using the piezoelectric actuators 400, the movement amount and movement speed of the first, second, third, and fourth stage drive sections 45, 46, 47, and 48 can be finely and precisely controlled, and the movement direction can be quickly switched. It is also possible to reduce the size and weight of the first vibration generation device 4. As a result, the increase in the weight of the tip end portion of the robot main body 30 can be suppressed, and deterioration of drive characteristics such as responsiveness and vibration damping of the robot main body 30 can be effectively suppressed.

The first vibration generation device 4 has been described above. However, the configuration of the first vibration generation device 4 is not particularly limited. For example, the number of stages that move with respect to the base portion 40 is not particularly limited, and may be three or less, or five or more. The first, second, third, and fourth stage drive sections 45, 46, 47, and 48 may be configured with a drive source other than the piezoelectric actuator 400, such as a motor that rotates when energized. The placement of the first vibration generation device 4 is not limited as long as it can vibrate the print head 39. For example, it can be located between the robot main body 30 and the mount base 10.

The first vibration meter 5 is located on the print head 39 and detects vibration of the print head 39. The term “vibration” above means a displacement other than a displacement along the print trajectory Q (to be described later). The first vibration meter 5 is a three-axis acceleration sensor, and, as shown in FIG. 3, has a rectangular shaped housing 51, and an acceleration sensor unit 52 and a control IC 53 housed in the housing 51.

The dimensions of the housing 51 are not particularly limited, but for example, the width × depth × height are desirably equal to or less than 62.4 mm×46.2 mm×36.2 mm, respectively. The weight of the housing 51 is not particularly limited, but it is desirably 100 g or less, for example. By this, the first vibration meter 5 becomes sufficiently small in size and light in weight, and the freedom of placement of the first vibration meter 5 increases. In addition, increase in the weight of the tip end portion of the robot main body 30 can be suppressed, and the deterioration of the responsiveness, vibration damping, or the like of the robot main body 30 can be effectively suppressed.

The acceleration sensor unit 52 has an acceleration sensor 52x for detecting acceleration in the x-axis direction, an acceleration sensor 52y for detecting acceleration in the y-axis direction, and acceleration sensor 52z for detecting an acceleration in the z-axis direction. The acceleration sensors 52x, 52y, and 52z each have a detection element 54 shown in FIG. 4.

The detection element 54 has a substrate structure body 541, and a quartz crystal oscillation element 542 and a weight section 543, which are fixed to a surface of the substrate structure body 541. The substrate structure body 541 is formed of a quartz substrate, and has a base section 541a and a movable section 541b extending from the base section 541a. The weight section 543 is located at the tip end portion of the movable section 541b. The quartz crystal oscillation element 542 is a twin-tuning fork type quartz crystal element formed from the quartz substrate. One end portion of the quartz crystal oscillation element 542 is fixed to the base section 541a, the other end portion is fixed to the movable section 541b. Although not shown in the drawing, a pair of excitation electrodes are provided on each of the vibration beams 542a and 542b of the quartz crystal oscillation element 542, and when AC voltage is applied between these excitation electrodes, the two vibration beams 542a and 542b perform bending vibration so that they repeatedly approach and separate from each other.

When acceleration is applied to the detection element 54 in the thickness direction, the movable section 541b bends. By this, tensile stress or compressive stress is applied to the quartz crystal oscillation element 542, and the resonance frequency of the quartz crystal oscillation element 542 changes in accordance with the magnitude of the applied stress. Accordingly, the acceleration can be detected based on the change in the resonance frequency of the quartz crystal oscillation element 542.

In the accelerometer 52x, the thickness direction of detection element 54 coincides with the x-axis direction, in the accelerometer 52y, the thickness direction of detection element 54 coincides with the y-axis direction, and in the accelerometer 52z, the thickness direction of detection element 54 coincides with the z-axis direction. Therefore, the acceleration sensors 52x, 52y, and 52z can detect acceleration in the x-axis, y-axis, and z-axis directions, respectively. Here, the quartz crystal oscillation element 542 has superior frequency-temperature characteristics compared to elements formed from other piezoelectric materials and to elements formed from silicon, which like crystal is commonly used as a material for sensor elements. Therefore, temperature-compensation can be performed with high accuracy. Further, since the circuit measures the frequency change, the analog elements can be eliminated from the circuit and noise becomes low. Therefore, it is possible to accurately detect the vibration of the print head 39.

The control IC 53 is, for example, a micro controller unit (MCU), and has a control circuit that controls a drive of the acceleration sensor unit 52 and an interface circuit that communicates with the outside. Of these, the control circuit drives the acceleration sensors 52x, 52y, and 52z, and detects acceleration in each axial direction based on the resonance frequency of the quartz crystal oscillation element 542 provided in the acceleration sensors 52x, 52y, and 52z. On the other hand, the interface circuit transmits and receives signals to and from the control device 9. The interface circuit receives commands from the control device 9 or outputs detected acceleration information to the control device 9. Here, the control IC 53 wirelessly transmits and receives signals to and from the control device 9. By this, the signal line does not need to be routed. This facilitates the installation of the first vibration meter 5 and increases the degree of freedom of installation places. The wireless communication standard is not particularly limited, and Wi-Fi, Bluetooth (registered trademark), or the like can be used. In this embodiment, Bluetooth is used. By this, power saving can be achieved.

A maximum sampling rate of the first vibration meter 5 is not particularly limited, but is desirably 1000 Hz or more. By this, each acceleration can be acquired at a sufficiently high sampling rate, and the vibration of the print head 39 can be detected with a high degree of accuracy. Noise density of the first vibration meter 5 is not particularly limited, but is desirably 0.2 μG/√ Hz or less. By this, noise is sufficiently suppressed and vibration of the print head 39, especially low-frequency vibration, can be detected with high degree of accuracy. In particular, this characteristic is better demonstrated because the vibrations generated in the print head 39 during printing are only a few Hz to several tens of Hz. Note that the noise density is the average value of noise density at 0.5 Hz to 6 Hz at 25° C. expressed as Typ. value. The maximum measurement frequency of the first vibration meter 5 is desirably 460 Hz or more. By this, it is possible to sufficiently cover the frequency band of the vibration that may be generated in the print head 39, and it is possible to detect the vibration of the print head 39 with a high degree of accuracy.

The first vibration meter 5 has been described above. However, the configuration of the first vibration meter 5 is not particularly limited as long as the vibration of the print head 39 can be detected. For example, the detection element 54 that the acceleration sensors 52x, 52y, and 52z have may be a silicon MEMS. The silicon MEMS has, for example, a comb-shaped fixed electrode and a comb-shaped movable electrode which are located so as to be engaged with each other. The silicon MEMS can be configured to detect acceleration based on a change in electrostatic capacitance between the fixed electrode and the movable electrode that is caused by the displacement of the movable electrode with respect to the fixed electrode due to the acceleration received. The location of the first vibration meter 5 is not particularly limited as long as the vibration of the print head 39 can be detected, and for example, the first vibration meter 5 may be located on the fourth stage 44 of the first vibration generation device 4.

1.2. Holding device 2

As shown in FIG. 1, the holding device 2 has a holding section 20 that holds the print object W, a second vibration generation device 6 that vibrates the holding section 20, and a second vibration meter 7 that detects vibration of the print object W.

The holding section 20 has a placement section 21 on which the print object W is placed, and a pair of claw sections 22 and 23 that clamp and fix the print object W. However, the configuration of the holding section 20 is not particularly limited as long as it can hold the print object W, and can be appropriately designed depending on a shape of print object W, location of surface to be printed on, and the like.

The second vibration generation device 6 is located between the holding section 20 and the mount base 10. The second vibration generation device 6 is a device that applies vibration to the print object W. The second vibration generation device 6, which has a similar configuration to the first vibration generation device 4, is provided with, as shown in FIG. 5, a base portion 60 that is fixed to the mount base 10, a first stage 61 that moves in the X-axis direction with respect to the base portion 60, a second stage 62 that moves in the Y-axis direction with respect to the first stage 61, a third stage 63 that moves in the Z-axis direction with respect to the second stage 62, a fourth stage 64 that rotates around the Z-axis with respect to the third stage 63, a first stage drive section 65 that moves the first stage 61 with respect to the base portion 60, a second stage drive section 66 that moves the second stage 62 with respect to the first stage 61, a third stage drive section 67 that moves the third stage 63 with respect to the second stage 62, and a fourth stage drive section 68 that moves the fourth stage 64 with respect to the third stage 63. The holding section 20 is located on the fourth stage 64. Note that these sections have the same configuration as the aforementioned first vibration generation device 4, so the description of these sections is omitted.

The second vibration generation device 6 has been described above. However, the configuration of the second vibration generation device 6 is not particularly limited. The second vibration generation device 6 may have a configuration different from that of the first vibration generation device 4. The location of the second vibration generation device 6 is not particularly limited as long as the print object W can be vibrated.

As shown in FIG. 2, the second vibration meter 7 is located on the holding section 20 and detects vibration of the print object W. The second vibration meter 7 is the same as the first vibration meter 5 described above. That is, the second vibration meter 7 is a three-axis acceleration sensor. The second vibration meter 7 has a rectangular shaped housing 71, and an acceleration sensor unit 72 and a control IC 73 housed in the housing 71. The acceleration sensor unit 72 has an acceleration sensor 72x for detecting acceleration in the X-axis direction, an acceleration sensor 72y for detecting acceleration in the Y-axis direction, and an acceleration sensor 72z for detecting acceleration in the Z-axis direction. Note that these sections have the same configuration as the aforementioned first vibration meter 5, so the description of these sections is omitted.

The second vibration meter 7 has been described above. However, the configuration of the second vibration meter 7 is not particularly limited as long as the vibration of the print object W can be detected. The second vibration meter 7 may have a different configuration from the first vibration meter 5. The location of the second vibration meter 7 is not particularly limited as long as the vibration of the print object W can be detected, and for example, the second vibration meter 7 may be directly placed on the print object W. If the second vibration meter 7 is provided directly on the print object W, the vibration of the print object W can be detected with a high degree of accuracy. However, the workability deteriorates because the second vibration meter 7 has to be replaced and calibrated every time a new print object W is set in the holding section 20 after printing is finished. Therefore, in this embodiment, the second vibration meter 7 is located on the holding section 20 to achieve both workability and accuracy.

1.3. Control device 9

The control device 9 controls drive of the first robot 3 and the holding device 2. The control device 9 comprises, for example, a computer, which includes a processor for processing information (CPU), a memory communicatively connected to the processor, and an external interface for connecting to an external device. Various programs executable by the processor are stored in the memory, and the processor can read and execute the programs and the like stored in the memory.

The configuration of the robot system 1 has been described above. Next, a printing method for performing printing on the print object W using such a robot system 1 will be described.

1.4. Printing method

The printing using the robot system 1 is performed, as described above, by ejecting ink from the print head 39 onto the surface to be printed on while moving the print head 39 along the surface to be printed on of the print object W at a predetermined print trajectory Q and at a predetermined speed. However, if, during printing, a relative vibration occurs between the print head 39 and the print object W, that is, a displacement between the print head 39 and the print object W other than movement of the print head 39 along the print trajectory Q, the actual trajectory of the print head 39 with respect to the print object W deviates from the print trajectory Q and print quality deteriorates. The relative vibration between the print head 39 and the print object W is also simply referred to as “relative vibration” hereinafter.

The relative vibration occurs, for example, as follows. As shown in FIG. 6, the drive of the robot main body 30 causes vibration V1 in the print head 39. The vibration V1 is then transmitted to the mount base 10 via robot main body 30, which causes the mount base 10 to vibrate a vibration V2. Further, the vibration V2 is transmitted to the holding device 2, which causes a vibration V3 in the holding device 2. As a result, a vibration V4, in which the vibrations V2 and V3 are superimposed, is caused on the print object W. In this way, different vibrations V1 and V4 occur in the print head 39 and the print object W, respectively, and as a result, a relative vibration occurs between the print head 39 and the print object W.

Therefore, in the printing method using the robot system 1, the relative vibration is detected, and printing is performed, while vibrating at least one of the robot arm 32, the print head 39, and the print object W, so that the detected relative vibration becomes smaller or, desirably, disappears. By this, deviation between an actual trajectory of the print head 39 with respect to the print object W and the print trajectory Q is reduced compared to the case where the print head 39 is not vibrated, and printing on the print object W can be performed with a high degree of accuracy. Therefore, deterioration of print quality can be effectively suppressed. Note that the term “detect relative vibration” means to obtain a direction and magnitude of relative vibration.

The control device 9 obtains the relative vibration from the difference between the vibration V1 in the print head 39 and the vibration V4 in the print object W. Specifically, in the robot system 1, the vibration V1 in the print head 39 is obtained by using the first vibration meter 5, the vibration V4 in the print object W is obtained by using the second vibration meter 7, and the relative vibration is obtained from the difference between the obtained vibrations V1 and V4. According to such a method, the relative vibration can be easily detected. In particular, since the first vibration meter 5 is located on the print head 39 and the second vibration meter 7 is located on the holding section 20, the relative vibration can be detected with high degree of accuracy. However, the method of detecting the relative vibration is not particularly limited.

The control device 9 drives at least one of the robot arm 32, the first vibration generation device 4, and the second vibration generation device 6 to apply a counteracting vibration to at least one of the print head 39 and the print object W so that the relative vibration becomes smaller or, desirably, disappears. The “counteracting vibration” is not particularly limited as long as it can cancel out at least a part of the relative vibration, but is desirably a vibration having an opposite phase to that of the relative vibration. By this, theoretically, all of the relative vibration cancels out and the relative vibration will disappear. Therefore, deterioration of the print quality can be suppressed more effectively.

The method of applying the counteracting vibration includes (a) a method of applying a counteracting vibration to the print head 39 by driving the robot arm 32, (b) a method of applying a counteracting vibration to the print head 39 by driving the first vibration generation device 4, (c) a method of applying the counteracting vibration to the print object W by driving the second vibration generation device 6, (d) a method of applying a counteracting vibration to the print head 39 by driving the robot arm 32 and the first vibration generation device 4, (e) a method of applying a counteracting vibration between the print head 39 and the print object W by driving the robot arm 32 and the second vibration generation device 6, (f) a method of applying a counteracting vibration between the print head 39 and the print object W by driving the first vibration generation device 4 and the second vibration generation device 6, and (g) a method of applying a counteracting vibration between the print head 39 and the print object W by driving all of the robot arm 32, the first vibration generation device 4, and the second vibration generation device 6, and one of these methods can be selected and performed. In the cases of (e) to (g), the print head 39 and the print object W may be vibrated so that the combined vibration of the vibration in the print head 39 and the vibration in the print object W becomes the counteracting vibration.

According to such a method, at least a part of the relative vibration is eliminated by the counteracting vibration, and the relative vibration becomes smaller than that in the case where the counteracting vibration is not applied. As a result, the deviation between the actual trajectory of print head 39 with respect to the print object W and the print trajectory Q is reduced, and deterioration of the print quality can be effectively suppressed. In particular, when only the print head 39 is subjected to counteracting vibration, as in (a), (b) and (d), the print object W can be held stationary. Therefore, shifting or detachment of the print object W from the holding device 2 can be suppressed. On the other hand, when only the print object W is vibrated, as in (c), the print head 39 does not need to be caused to move other than along the print trajectory Q, so the drive of the first robot 3 becomes smooth. Therefore, in both cases, the deterioration of print quality can be effectively suppressed.

When applying counteracting vibration to two or more among the robot arm 32, the first vibration generation device 4 and the second vibration generation device 6, but including the robot arm 32, as in (d), (e) and (g), it is desirable to do the following. The relative vibration includes a low-frequency relative vibration, which is below a predetermined frequency, and a high-frequency relative vibration, which is above the predetermined frequency. The predetermined frequency is not particularly limited, but is, for example, about 10 Hz. Since the robot arm 32 is heavier than the first and second vibration generation devices 4 and 6, the robot arm 32 is less responsive.

Therefore, in (d) case, a low-frequency counteracting vibration, which cancels out the low-frequency relative vibration, is applied to the print head 39 by driving the robot arm 32, and a high-frequency counteracting vibration, which cancels out the high-frequency relative vibration, is applied to the print head 39 by driving the first vibration generation device 4. The combination of the low-frequency counteracting vibration and the high-frequency counteracting vibration results in the counteracting vibration. Therefore, the relative vibration is reduced as a whole. Similarly, in (e) case, the low-frequency counteracting vibration is applied to the print head 39 by driving the robot arm 32, and the high-frequency counteracting vibration is applied to the print object W by driving the second vibration generation device 6. Further, in (g) case, the low-frequency counteracting vibration is applied to the print head 39 by driving the robot arm 32, and the high-frequency counteracting vibration is applied between the print head 39 and the print object W by driving the first and second vibration generating devices 4 and 6. As described above, by assigning frequency bands of the counteracting vibration that occurs in the robot arm 32 and the first and second vibration generating devices 4 and 6, counteracting vibrations with high accuracy can be applied without applying an excessive load on each section.

In addition, when counteracting vibration is applied by using two or more among the robot arm 32, the first vibration generation device 4, and the second vibration generation device 6, as shown in (d) to (g), directions of vibration may be assigned to them. Using (f) for a representative explanation, for example, a first counteracting vibration, which cancels out the vibration components in the X-axis and Y-axis of the relative vibration, may be applied to the print head 39 by driving the first vibration generation device 4, and a second counteracting vibration, which cancels out the vibration component in the Z-axis of the relative vibration, may be applied to the print object W by driving the second vibration generation device 6. This method is effective when the vibration components that can be caused by the first and second vibration generation devices 4 and 6 are different and when one of them alone cannot generate the counteracting vibration. In addition, for example, the magnitude of the vibration may be assigned. Using (f) for a representative explanation, for example, a first counteracting vibration, which has magnitude of 1/2 of the relative vibration, may be applied to the print head 39 by using the first vibration generation device 4, and a second counteracting vibration, which has magnitude of the remaining 1/2 of the relative vibration, may be applied to the print object W by using the second vibration generation device 6. This method is effective when the outputs of the first and second vibration generation devices 4 and 6 are insufficient and when one of them alone cannot generate the counteracting vibration.

Next, the timing for detecting the relative vibration will be described. For example, the relative vibration may be detected by performing a trial movement of the print head 39 before printing. Specifically, before printing, the print head 39 is moved, without ejecting any ink from the print head 39, at the same print trajectory Q and speed as during actual printing. A relative vibration during this process is then detected, and a counteracting vibration is determined based on the detected relative vibration. Then, actual printing is performed while applying the determined counteracting vibration between the print head 39 and the print object W by using any one of the aforementioned methods. In other words, the printing on the print object W is performed by moving the print head 39 along the print trajectory Q at a predetermined speed while ejecting ink from the print head 39 while applying the counteracting vibration between the print head 39 and the print object W. According to this method, since the counteracting vibration can be determined in advance, the control of the robot system 1 is facilitated.

The relative vibration may be detected during printing. Specifically, the print head 39 is started to move at a predetermined speed along the print trajectory Q for printing, and the relative vibration detection is started. Each time the latest relative vibration is detected, a counteracting vibration is determined to cancel it out. The determined counteracting vibration is applied between the print head 39 and the print object W by using any one of the aforementioned ways. That is, the relative vibration is detected in real time during printing, and the detected result is fed back to the counteracting vibration. In this way, according to the method of detecting the relative vibration while performing the printing, the trial movement for detecting the relative vibration in advance is unnecessary. Therefore, the work efficiency of printing is improved.

The robot system 1 has been described above. As described above, the printing method performed by using the robot system 1 is a printing method of performing printing on the print object W by using the print head 39 that is provided in the first robot 3, and performs printing by relatively moving the print head 39 and the print object W while vibrating at least one of the print head 39 and the print object W so as to reduce the relative vibration between the print head 39 and the print object W. According to this printing method, since the relative vibration between the print head 39 and the print object W is suppressed, the deviation between the actual trajectory of the print head 39 and the print trajectory Q with respect to the print object W is reduced, and printing on the print object W can be performed with high degree of accuracy. Therefore, deterioration of print quality can be effectively suppressed.

Further, as described above, the printing method detects vibration of either the print head 39 or the print object W, and the printing is performed while vibrating at least one of the print head 39 and the print object W. By this, vibration that can more reliably reduce the relative vibration can be applied to the print head 39 and the print object W.

As described above, the printing method can detect the relative vibration by detecting each of the vibrations of the print head 39 and the print object W. By this, the detection of the relative vibration can be facilitated.

In addition, as described above, the printing method has the first vibration meter 5 for detecting the vibration of the print head 39, and the second vibration meter 7 for detecting the vibration of the print object W. By this, since the vibration of the print head 39 and the vibration of the print object W can be detected with a high degree of accuracy, the relative vibration can be detected with a high degree of accuracy.

As described above, the printing method is provided with the first vibration meter 5 that has the quartz crystal oscillation element 542. Although not shown, the second vibration meter 7 also has a quartz crystal oscillation element similar to the quartz crystal oscillation element 542. By this, it is possible to detect each of the vibrations of the print head 39 and the print object W with a high degree of accuracy.

As described above, the printing method may also reduce the relative vibration by vibrating only the print head 39, of the print head 39 and the print object W. According to this method, since the print object W can be held stationary, the deviation of the print object W can be suppressed.

As described above, the printing method may reduce the relative vibration by vibrating only the print object W, of the print head 39 and the print object W. According to this method, since the print head 39 can be held stationary in an operation for vibration damping, the first robot 3 can be driven more smoothly.

As described above, the printing method performs printing while detecting the relative vibration. According to this method, the relative vibration can be detected in real time during the printing, and the detection result can be fed back. Therefore, the relative vibration during the printing can be reduced more reliably.

As described above, the printing method may perform printing after the relative vibration was detected. According to this method, the relative vibration only needs to be detected once before printing. Therefore, the control can be facilitated.

As described above, the robot system 1 has a first robot 3 provided with a print head 39 for printing on the print object W. The robot system 1 performs printing by relatively moving the print head 39 and the print object W while vibrating at least one of the print head 39 and the print object W so that the relative vibration between the print head 39 and the print object W is reduced. According to this configuration, the relative vibration between the print head 39 and the print object W is suppressed. Therefore, the deviation between the actual trajectory of the print head 39 and the print trajectory Q with respect to the print object W is reduced and the printing on the print object W can be performed with a high degree of accuracy. Therefore, deterioration of print quality can be effectively suppressed.

### 2. Second Embodiment

A robot system 1 according to this embodiment is the same as the robot system 1 of the first embodiment described above except that the printing method is different. In the following description of the robot system 1 in this embodiment, description will focus on the differences from the aforementioned first embodiment and description of similar matters will be omitted.

In the printing method of this embodiment, the relative vibration is not detected. The vibration of the print head 39 is canceled out by the drive of the first vibration generation device 4, and the vibration of the print object W is canceled out by the drive of the second vibration generation device 6. Specifically, the control device 9 detects a print head vibration, which is the vibration of print head 39, by using the first vibration meter 5, and applies a print head counteracting vibration, which cancels out the print head vibration, to the print head 39 by using the first vibration generation device 4. By this, the vibration of print head 39 can be reduced. Similarly, the control device 9 detects a print object vibration, which is the vibration of print object W, by using the second vibration meter 7, and applies a print object counteracting vibration, which cancels out the print object vibration, to the print object W by using the second vibration generation device 6. By this, the vibration of print object W can be reduced. In this way, the relative vibration is reduced by reducing vibration of the print head 39 and vibration of the print object W. Alternatively, vibration of one of the print head 39 and the print object W may be detected, and a counteracting vibration for canceling out the detected vibration may be applied to the other. By this, the relative vibration is reduced. According to this method, the relative vibration can be more reliably reduced without detecting the relative vibration.

According to the second embodiment as described above, the same effects as those of the first embodiment described above can be exhibited.

### 3. Third Embodiment

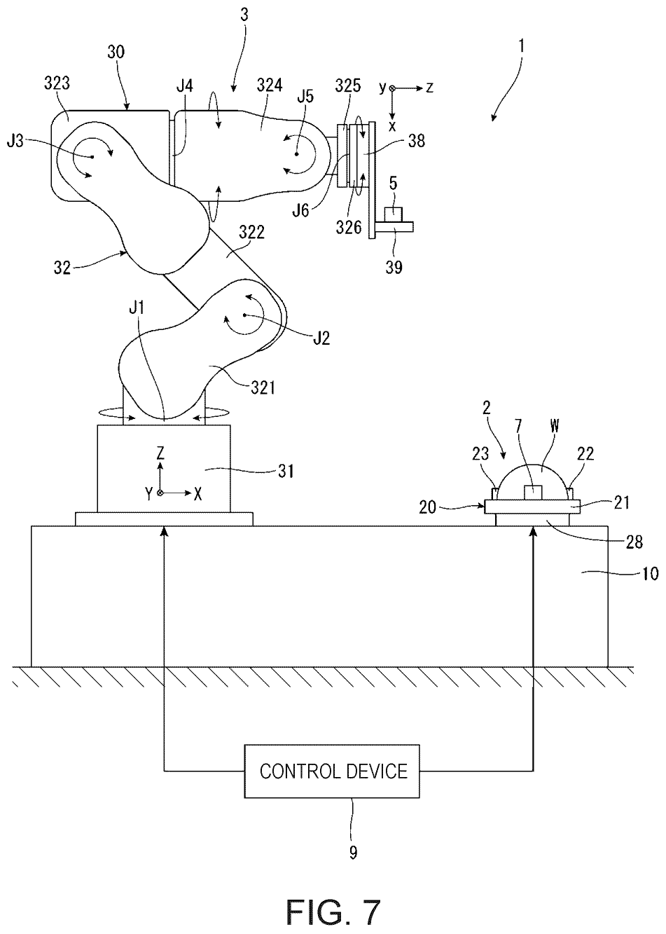

FIG. 7 is an overall view of the robot system according to a third embodiment.

A robot system 1 according to this embodiment is the same as the robot system 1 of the first embodiment described above except that a first damping member 38 and a second damping member 28 are provided instead of the first vibration generation device 4 and the second vibration generation device 6. In the following description of the robot system 1 in this embodiment, description will focus on the differences from the aforementioned first embodiment and description of similar matters will be omitted. In the drawings of this embodiment, the same components as those of the above described embodiment are denoted by the same reference numerals.

As shown in FIG. 7, in the robot system 1 of this embodiment, the first vibration generation device 4 is omitted from the first robot 3, and instead, a first damping member 38 is located between the arm 326 and the print head 39. The second vibration generation device 6 is also omitted from the holding device 2, and instead, the second damping member 28 is located between the mount base 10 and the holding section 20. The first and second damping members 38 and 28 are made of, for example, a rubber material, and can absorb at least a part, desirably all, of the high-frequency relative vibration included in the relative vibration. The low-frequency relative vibration included in the relative vibration that cannot be absorbed by the first and second damping members 38 and 28 is canceled out by applying a low-frequency counteracting vibration to the print head 39 by using the robot arm 32. According to this configuration, for example, since the configuration is simpler than the first embodiment described above, its control is facilitated.

Such a third embodiment can also exhibit the same effects as the first embodiment described above.

### 4. Fourth Embodiment

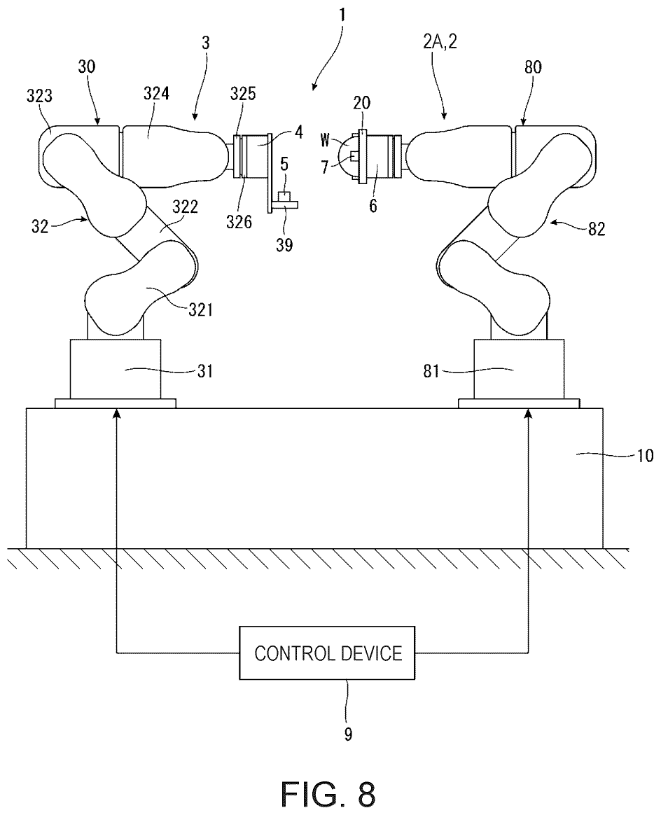

FIG. 8 is an overall view of the robot system according to a fourth embodiment.

A robot system 1 according to this embodiment is the same as the robot system 1 of the first embodiment described above except that a configuration of holding device 2 is different. In the following description of the robot system 1 in this embodiment, description will focus on the differences from the aforementioned first embodiment and description of similar matters will be omitted. In the drawings of this embodiment, the same components as those of the above described embodiment are denoted by the same reference numerals.

As shown in FIG. 8, the holding device 2 is a second robot 2A. The second robot 2A has a robot main body 80, a holding section 20, which is located at a tip end portion of the robot main body 80, a second vibration generation device 6, which is located between the robot main body 80 and the holding section 20, and a second vibration meter 7, which is located in the holding section 20.

The robot main body 80 is a six axes vertical articulated robot and has the same configuration as the robot main body 30 of the first robot 3. In other words, the robot main body 80 has a base 81, which is fixed to the mount base 10, and a robot arm 82, which is pivotably connected to the base 81. The holding section 20 is located at the tip end side of the robot arm 82, the second vibration generation device 6 is located between the robot arm 82 and the holding section 20, and the second vibration meter 7 is located in the holding section 20. According to this configuration, the position and posture of the print object W can be changed by driving the second robot 2A. Therefore, the surface to be printed on of the print object W can be set a position and posture that facilitate printing by the first robot 3. Therefore, printing can be facilitated.

As described above, this embodiment has the holding device 2 that holds the print object W, and the holding device 2 is the second robot 2A. According to this configuration, the position and posture of the print object W can be changed by driving the second robot 2A. Therefore, the surface to be printed on of the print object W can be set a position and posture that facilitate printing by the first robot 3. By this, the printing can be facilitated.

Such a fourth embodiment can also exhibit the same effects as the first embodiment described above.

The printing method and the robot system according to this disclosure have been described with reference to the illustrated embodiments. However, the disclosure is not limited thereto, and the configuration or the process of each section can be replaced with an arbitrary configuration or process having the same function. Further, other arbitrary components or processes may be added to this disclosure. Further, each embodiment may be appropriately combined.

1. A printing method of performing printing on a print object using a print head that is provided to a first robot, the printing method comprising:
performing printing by relatively moving the print head and the print object, while vibrating at least one of the print head and the print object, so that relative vibration between the print head and the print object is reduced.

2. The printing method according to claim 1, wherein
printing is performed by detecting vibration of at least one of the print head and the print object, and by vibrating at least one of the print head and the print object.

3. The printing method according to claim 1, wherein
the relative vibration is detected by detecting vibration of the print head and vibration of the print object.

4. The printing method according to claim 3, wherein
a first vibration meter, which detects vibrations of the print head, and a second vibration meter, which detects vibrations of the print object, are provided.

5. The printing method according to claim 4, wherein
each of the first vibration meter and the second vibration meter has a quartz crystal oscillation element.

6. The printing method according to claim 1, wherein
amongst the print head and the print object, the relative vibration is reduced by vibrating only the print head.

7. The printing method according to claim 1, wherein
amongst the print head and the print object, the relative vibration is reduced by vibrating only the print object.

8. The printing method according to claim 7, wherein
a holding device, which holds the print object, is provided and the holding device is a second robot.

9. The printing method according to claim 2, wherein
printing is performed while detecting the relative vibration.

10. The printing method according to claim 2, wherein
printing is performed after the relative vibration was detected.

11. A robot system comprising:
a first robot, which has a print head for printing on a print object, wherein
printing is performed by relatively moving the print head and the print object, while vibrating at least one of the print head and the print object, so that relative vibration between the print head and the print object is reduced.
